(19) United States
(12) Patent Application Publication
(10) Pub. No.: US 2023/0287216 A1
(43) Pub. Date: Sep. 14, 2023

(54) COMPOSITE ORGANIC BINDER AND METHODS OF PREPARING AND USING THE SAME

(71) Applicant: CENTRAL SOUTH UNIVERSTIY, Changsha City (CN)

(72) Inventors: Qian LI, Changsha City (CN); Yonghe MA, Changsha City (CN); Xuling CHEN, Changsha City (CN); Yongbin YANG, Changsha City (CN); Tao JIANG, Changsha City (CN)

(73) Assignee: CENTRAL SOUTH UNIVERSTIY, Changsha CIty (CN)

(21) Appl. No.: 17/708,924

(22) Filed: Mar. 30, 2022

(30) Foreign Application Priority Data
Mar. 11, 2022 (CN) 202210236671.2

(51) Int. Cl. C08L 97/02

(52) U.S. Cl. CPC C08L 97/02

(57) ABSTRACT

A composite organic binder and methods for preparing and using the same are disclosed. The composite organic binder is made of the following components in mass percentages: 0.97-1.13% of polyethylene oxide and 98.87-99.03% of a papermaking sludge. The composite organic binder could solve the problems of high residual rate, poor pellet strength and low pellet iron grade existing in the process of producing iron ore pellets with bentonite and other binders. Results of examples show that green pellets have higher strength and shock temperature and the finished pellets have higher iron grade and excellent metallurgical properties, if the composite organic binder is used in an amount of 0.4-0.6% of the dry weight of iron ore concentrate.

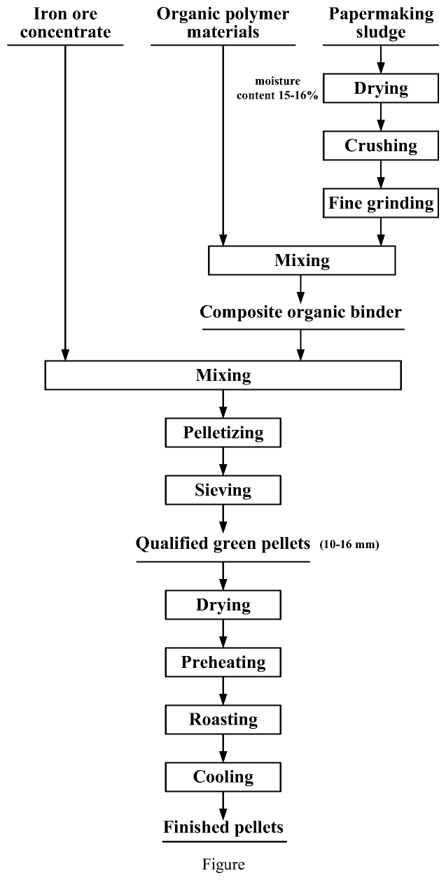

### TECHNICAL FILED

The present disclosure relates to the technical field of iron and steel metallurgy, especially to a composite organic binder and methods of preparing and using the same.

### BACKGROUND ART

The steel industry is an important basic industry for the development of a country. China is the world's largest steel producer, with a crude steel production reaching 1.053 billion tons in 2020, accounting for 56.50% of the world's total crude steel production. Steel production process in China is dominated by a blast furnace-converter long process, while using coal as the main energy source, making the steel industry a major carbon emitter. Agglomeration is the key link of carbon reduction in the long process of steel production, and iron ore concentrate agglomeration technology mainly includes sintering, pelletizing and briquetting.

The burden structure of blast furnace in China is mainly sinter, with pellets and a small amount of lump ore. Compared with sintering, the pelletizing has a lower energy consumption, being only ½ of that of sintering; has a smaller pollution in terms of the dust, SO₂ and NOₓ emissions, being only 1/7, ⅕ and ⅓ of that of sintering, respectively; and results in pellets having uniform particle size, high cold strength, high iron grade and excellent metallurgical properties. Nowadays, with the rapid growth of steel production capacity, carbon emissions in the steel industry have long been high, the sinter-based burden structure of blast furnace is constantly adjusted, the ratio of pellets feeding into the blast furnace has increased sharply year by year and the quality of pellets and production costs have also become the main bottleneck for the blast furnace to improve quality and reduce consumption.

Nowadays, the binder used in pelletizing is mainly bentonite, which is an aluminosilicate mineral with montmorillonite as the main component. Depending on the types of cations adsorbed between crystal layers of montmorillonite, bentonite could be divided into sodium-based, calcium-based and magnesium-based bentonite. Bentonite is used in pellet production with a general dosage of 2-3%, or even higher. It is shown from production practice that with the addition of 1% of bentonite, the iron grade of pellets is reduced by about 0.6-0.7%. However, if the iron grade of the burden is increased by 1%, the coke ratio could be reduced by 2%, and the output of pig iron could be increased by 3%. Therefore, reducing the amount of bentonite or completely replacing bentonite in pelletizing, increasing the iron grade of pellets, and delivering high-quality pellets to the blast furnace are of great significance to quality improvement, consumption reduction, energy saving and emission reduction for blast furnace.

In order to improve the iron grade of pellets, researchers in China and other countries have devoted themselves to developing organic binders. For example, Peridur has been tried frequently in countries outside China, and sodium carboxymethyl cellulose, cellulose, humic acid, starch, guar gum, etc. have been tested in China. However, none of them has been widely used. The main reasons are as follows: (1) in pellet production, the above binders are used in an amount of generally about 0.5%, and organic compounds with high amount will form a reducing atmosphere when pellets are preheated, which will hinder the oxidation process of pellets and result in low shock temperature and poor strength of the preheated pellets, and thereby the preheating time is prolonged and the production efficiency is reduced; (2) the organic binder alone is largely burnt out in the process of pellet roasting, the slag connection between pellets is small, and the strength of roasted pellets is low. In order to solve the above problems, researchers mostly use organic materials with high viscosity to compound inorganic carrier to prepare a composite binder. Patents such as CN110004290A, CN110724815B, CN110629020A, CN104651607B, CN113293284A disclose the following inorganic carriers: bentonite, fly ash, iron-containing tailings, dust removal ash, converter mud, magnesium oxide powder, dead burned high-irm-magnesite. These inorganic carriers have the following defects: (1) some of these carriers have poor water absorption or bonding properties; (2) they have high impurity content and thus result in large residual amount during roasting, which seriously affects the iron grade of pellets; and (3) they could not completely replace bentonite in the production of iron ore pellets.

### SUMMARY

An object of the present disclosure is to provide a composite organic binder and methods of preparing and using the same. The composite organic binder according to the present disclosure allows for solving problems such as high residue rate, poor pellet strength and low iron grade of pellets when producing iron ore pellets with bentonite and other binders.

In order to achieve the above object, the present disclosure provides the following technical solutions.

Provided is a composite organic binder, which is made of the following components in mass percentages: 0.97-1.13% of polyethylene oxide, and 98.87-99.03% of a papermaking sludge.

In some embodiments, the polyethylene oxide has a number average molecular weight of 6.5-8.5 million.

In some embodiments, the polyethylene oxide has a mass fraction of polyethylene oxide with a particle size not larger than 0.074 mm of not less than 99%.

In some embodiments, the papermaking sludge has a mass content of organic matters of 40-50%.

In some embodiments, the papermaking sludge has a mass fraction of papermaking sludge with a particle size not larger than 0.074 mm of not less than 90%.

In some embodiments, the papermaking sludge has a moisture content of 15-16%.

Provided is a method for preparing the composite organic binder described in the above technical solutions, comprising mixing polyethylene oxide and the papermaking sludge according to the composition ratio described above to obtain the composite organic binder.

Provided is a method of using the composite organic binder described in the above technical solutions or prepared by the method described in the above technical solutions, including the following steps: mixing the composite organic binder and an iron ore concentrate powder, and pelletizing to obtain iron ore pellets.

In some embodiments, the iron ore concentrate powder has a mass fraction of iron ore concentrate powder with a particle size not larger than 0.074 mm of not less than 85%, and a specific surface area of not less than 1500 cm²/g.

In some embodiments, the composite organic binder is used in an amount of 0.4-0.6% of the dry weight of the iron ore concentrate powder.

Provided is a composite organic binder, which is made of the following components in mass percentages: 0.97-1.13% of polyethylene oxide, and 98.87-99.03% of a papermaking sludge.

The composite organic binder according to the present disclosure is obtained by compounding polyethylene oxide and the papermaking sludge. When polyethylene oxide is dissolved in water (water is added during the pelletizing process), the viscosity of the resulting solution increases rapidly, and a large number of functional groups in its molecular structure are easily adsorbed chemically on the surface of the iron ore concentrate, which significantly improves the molecular binding force between greenpellets. The polyethylene oxide is fully burnt when the pellets are preheated and roasted, and thereby does not affect the iron grade of the pellets. The papermaking sludge contains organic matters of mainly cellulose, hemicellulose and lignin, etc., and inorganic matters of mainly compounds of Ca, Al, Si, K, Fe, Mg and other metal elements. The papermaking sludge not only has good water absorption and bonding performance, but also has high content of Fe, Ca, Mg and other metal elements, which could enhance the dispersion of organic binder in iron ore concentrate when used as an organic binder carrier to prepare iron ore pellets. The organic matters and inorganic matters in papermaking sludge act synergistically to avoid the formation of reductive atmosphere during pellet preheating; further a small amount of low-melting-point slag phase is generated during roasting, to ensure the pellet strength. The results of examples show that when the composite organic binder according to the present disclosure is used in an amount of 0.4-0.6% of the dry weight of iron ore concentrate, the prepared green pellets have higher strength and shock temperature, and the finished pellets have higher iron grade and excellent metallurgical properties.

Compared with the prior art, the technical solutions of the present disclosure have the following advantages:

(1) The composite organic binder according to the present disclosure could completely replace bentonite when producing iron ore pellets and improve the strength and thermal stability of green pellets, and meets the standard requirements of binders for iron ore pellets.

(2) Compared with bentonite, the composite organic binder according to the present disclosure results in less impurities such as SiO₂ and Al₂O₃ when producing iron ore pellets and basically does not affect the grade of the finished pellets, which is beneficial for increasing production, saving coking, saving energy and reducing emissions of the blast furnace and thus improving comprehensive economic benefits of steel industry.

(3) The carrier used in the present disclosure is papermaking sludge, which is obtained widely and cheaply, with high content of organic components, good bonding performance, and high content of metal elements such as Fe, Ca and Mg. When the papermaking sludge is used as a carrier, less impurities are brought and only procedures of dewatering, drying, crushing and fine grinding are required for preparation, with short process and low energy consumption, which is conducive to energy saving and emission reduction.

### BRIEF DESCRIPTION OF THE DRAWINGS

FIGURE shows a flow chart of preparation and use of the composite organic binder according to an embodiment of the present disclosure.

### DETAILED DESCRIPTION OF THE EMBODIMENTS

The present disclosure provides a composite organic binder, which is made of the following components in mass percentages: 0.97-1.13% of polyethylene oxide, and 98.87-99.03% of a papermaking sludge.

In some embodiments, the polyethylene oxide has a number average molecular weight of 6.5-8.5 million, preferably 7-8 million, and more preferably 7.2-7.8 million. In some embodiments, the polyethylene oxide has a mass fraction of polyethylene oxide with a particle size not larger than 0.074 mm of not less than 99%. When polyethylene oxide is dissolved in water (water is added during pelletizing), the viscosity of the resulting solution increases rapidly, and the —OH in its molecular structure is adsorbed chemically on the surface of the iron ore concentrate, which significantly increases the molecular bonding force between the pellets. Further, the polyethylene oxide is fully burnt when the pellets are preheated and roasted, and thereby does not affect the iron grade of the pellets.

In some embodiments, the papermaking sludge has a mass content of organic matters of 40-50%. In some embodiments, the papermaking sludge has a mass content of inorganic matters of 50-60%. In some embodiments, the organic matters include at least one of cellulose, hemicellulose and lignin. In some embodiments, the inorganic matters include at least one of compounds of Ca, Al, Si, K, Fe, and Mg.

In some embodiments, the papermaking sludge has a mass fraction of papermaking sludge with a particle size not larger than 0.074 mm of not less than 90%. The reasons why the particle size of the papermaking sludge is controlled in the above range in the present disclosure are as follows: on the one hand, it is conductive to making the particles generate a large number of new interfaces and active sites, which could enhance the reactivity and facilitate the loading of polyethylene oxide; on the other hand, this particle size composition is more conducive to the dispersion of the composite organic binder.

In some embodiments, the papermaking sludge has a moisture content of 15-16%. In the present disclosure, the moisture content refers to the mass percentage content. By controlling the moisture content of the papermaking sludge in the above range, the technical solutions of the present disclosure could prevent polyethylene oxide from being agglomerated and difficult to disperse completely due to an excessive moisture content; and meanwhile prevent polyethylene oxide from being weakly absorbed on a surface of papermaking sludge due to a too low moisture content, which may result in segregation.

The papermaking sludge contains organic matters of mainly cellulose, hemicellulose and lignin, etc., and inorganic matters of mainly compounds of Ca, Al, Si, K, Fe, Mg and other metal elements. The papermaking sludge not only has good water absorption and bonding performance, but also has high content of Fe, Ca, Mg and other metal elements, which could enhance the dispersion of organic binder in iron ore concentrate when used as an organic binder carrier to prepare iron ore pellets. In addition, the organic matters and inorganic matters in papermaking sludge act synergistically to avoid the formation of reductive atmosphere during pellet preheating, while a small amount of low melting point slag phase is generated during roasting to ensure the pellet strength.

Provided is a method for preparing the composite organic binder mentioned in the above technical solutions, comprising mixing polyethylene oxide and the papermaking sludge according to the composition ratio described above to obtain the composite organic binder.

In some embodiments, the papermaking sludge is firstly dried, crushed and finely ground so that its moisture content and particle size meet the requirements. There is no special restriction on the mixing conditions in the present disclosure, and any mixing condition well known to those skilled in the art may be used.

Provided is a method of using the composite organic binder described in the above technical solutions or prepared by the method described in the above technical solutions, including the following steps: mixing the composite organic binder and an iron ore concentrate powder, and pelletizing to obtain iron ore pellets.

In some embodiments, the iron ore concentrate powder has a mass fraction of iron ore concentrate powder with a particle size not larger than 0.074 mm of not less than 85%. In some embodiments, the iron ore concentrate powder has a specific surface area of not less than 1500 cm²/g.

In some embodiments, the composite organic binder is used in an amount of 0.4-0.6% of the dry weight of the iron ore concentrate powder. In the present disclosure, the iron ore concentrate powder has been, or has not been pretreated by high pressure roller grinding or damp milling.

In some embodiments, under the condition that the iron ore concentrate powder has been pretreated by high pressure roller milling or damp milling, the composite organic binder is used in an amount of 0.4-0.6% of the dry weight of the iron ore concentrate powder; under the condition that the iron ore concentrate powder has not been pretreated by high pressure roller milling or damp milling, the composite organic binder is used in an amount of 0.5-0.6% of the dry weight of the iron ore concentrate powder.

In the present disclosure, there is no special restriction on the process of mixing the composite organic binder and the iron ore concentrate powder, and any process well known to those skilled in the art that could uniformly mix the two may be used. In the present disclosure, there is no special restriction on the pelletizing process, and any pelletizing process well known to those skilled in the art may be used.

FIGURE shows a flow chart of the preparation and use of the composite organic binder according to an embodiment of the present disclosure. As shown in FIGURE, in the present disclosure, polyethylene oxide is used as an organic polymer material and papermaking sludge is used as a carrier; the papermaking sludge is dried, crushed and finely ground to make the moisture content and particle size thereof meet the requirements; then the polyethylene oxide and the papermaking sludge are mixed, obtaining a composite organic binder; the composite organic binder is mixed with iron ore concentrate, and the resulting mixture is pelletized and screened, obtaining iron ore pellets, i.e. green pellets; and the green pellets are sequentially subjected to drying, preheating, roasting and cooling, obtaining finished pellets.

The composite organic binder and the preparation method and use thereof according to the present disclosure will be described below in conjunction with examples, which should not be understood as a limitation to the protection scope of the present disclosure.

In the following examples, the polyethylene oxide has an average molecular weight of 7 million, and the polyethylene oxide has a mass fraction of polyethylene oxide with a particle size not larger than 0.074 mm of 100%; the papermaking sludge has an organic matter content of 45%, an inorganic matter content of 55%, a moisture content of 15-16%, and a mass fraction of papermaking sludge with a particle size not larger than 0.074 mm of not less than 90%; the iron ore concentrate has a mass fraction of iron ore concentrate with a particle size not larger than 0.074 mm of not less than 85%, and a specific surface area of larger than 1500 cm²/g after high pressure roller grinding.

### Example 1

A composite organic binder was made of the following components in mass percentages: 0.97% of polyethylene oxide, and 99.03% of a papermaking sludge.

### Example 2

A composite organic binder was made of the following components in mass percentages: 1.05% of polyethylene oxide, and 98.95% of a papermaking sludge.

### Example 3

A composite organic binder was made of the following components in mass percentages: 1.13% of polyethylene oxide, and 98.87% of a papermaking sludge.

### Use Example 1

The composite organic binder in example 1 was mixed with a hydrous iron ore concentrate pretreated by the high pressure roller milling in an amount of 0.4% of the dry weight of the iron ore concentrate, and then the resulting mixture was pelletized, obtaining iron ore pellets. Properties of the iron ore pellets are shown in Table 1.

The iron ore pellets were preheated at a temperature of 950° C. for 10 min, and then roasted at a temperature of 1250° C. for 10 min. Properties of preheated pellets and roasted pellets are shown in Table 1.

### Use Example 2

The composite organic binder in example 2 was mixed with a hydrous iron ore concentrate pretreated by the high pressure roller milling in an amount of 0.5% of the dry weight of the iron ore concentrate, and then the resulting mixture was pelletized, obtaining iron ore pellets. Properties of the iron ore pellets are shown in Table 1.

The iron ore pellets were preheated and roasted under the conditions as shown in use example 1. Properties of preheated pellets and roasted pellets are shown in Table 1.

### Use Example 3

The composite organic binder in example 3 was mixed with hydrous iron ore concentrate pretreated by the high pressure roller milling in an amount of 0.6% of the dry weight of the iron ore concentrate, and then the resulting mixture was pelletized, obtaining iron ore pellets. Properties of the iron ore pellets are shown in Table 1.

The iron ore pellets were preheated and roasted under the conditions as shown in use example 1. Properties of preheated pellets and roasted pellets are shown in Table 1.

### Comparative Example 1

The hydrous iron ore concentrate pretreated by the high pressure roller milling and a calcium-based bentonite having a mass fraction of calcium-based bentonite with a particle size not larger than 0.074 mm of not less than 90% were fully mixed and pelletized, obtaining iron ore pellets. Wherein, the calcium-based bentonite was used in an amount of 3.0% of the dry weight of the iron ore concentrate. Properties of the iron ore pellets are shown in Table 1.

The iron ore pellets were preheated and roasted under the conditions as shown in use example 1. Properties of preheated pellets and roasted pellets are shown in Table 1.

### Comparative Example 2

The hydrous iron ore concentrate pretreated by the high pressure roller milling and a sodium-based bentonite having a mass fraction of sodium-based bentonite with a particle size not larger than 0.074 mm of not less than 90% were fully mixed and pelletized, obtaining iron ore pellets. Wherein, the sodium-based bentonite was used in an amount of 2.0% of the dry weight of the iron ore concentrate. Properties of the iron ore pellets are shown in Table 1.

The iron ore pellets were preheated and roasted under the conditions as shown in use example 1. Properties of preheated pellets and roasted pellets are shown in Table 1.

### Comparative Example 3

The hydrous iron ore concentrate pretreated by the high pressure roller milling and Peridur were fully mixed and pelletized, obtaining iron ore pellets. Wherein, the Peridur was used in an amount of 1.0% of the dry weight of the iron ore concentrate. Properties of the iron ore pellets are shown in Table 1.

The iron ore pellets were preheated and roasted under the conditions as shown in use example 1. Properties of preheated pellets and roasted pellets are shown in Table 1.

In Table 1, (1) Drop Number was Tested as Follows:

The iron ore pellets were dropped freely from a height of 0.5 m onto a 10 mm thick steel plate. Under the condition that the iron ore pellets ruptured after being dropped n times, the drop number of the pellets was (n−1) times/0.5 m. 20 pellets were measured each time, and the average value was taken as the drop number of this batch of pellets (unit: times/0.5 m).

(2) Compressive Strength was Tested as Follows:

The iron ore pellets were placed on an electronic balance, and a vertical downward pressure was slowly applied on an upper part thereof until the iron ore pellets just broke. The pressure value displayed by the electronic balance at this time was the compressive strength of iron ore pellets. 20 pellets were measured each time, and the average value was taken as the compressive strength of this batch of pellets (unit: N/P).

(3) Shock Temperature was Tested as Follows:

The shock temperature of iron ore pellets was determined in a vertical tube furnace of Φ650×1000 mm by referring to the dynamic determination method of AC Company in the United States. A room-temperature air from a jaeger blower was introduced into the tube furnace at a speed controlled by a rotor flowmeter. The tube furnace was heated by a resistance wire, and the temperature was controlled by an automatic temperature control meter. There was one Φ80×1200 mm stainless steel hot air pipe in the middle of the tube furnace, the stainless steel hot air pipe being equipped with Φ15 mm alumina porcelain balls with a height of 1000 mm. The porcelain balls was heated by the electric furnace so that the air blown in was heated quickly to become a hot air flow with constant temperature, and the thermocouple reflecting the temperature of the hot air was installed at the bottom of a drying cup for iron ore pellets. The drying cup used for holding iron ore pellets had an inner diameter of 50 mm and a height of 150 mm, with 13 mm round holes evenly arranged at the bottom, so that the airflow could enter the drying cup for drying. When measuring the shock temperature of iron ore pellets, 50 qualified pellets were taken and charged into the drying cup each time, and then the drying cup was placed in the vertical tube furnace with a wind speed of 1.5 m/s (cold state), and the pellets were taken out after staying in the furnace for 5 min. The highest temperature that the pellets could withstand when 4% of the pellets (i.e. 2 pellets) broke was recorded as the shock temperature.

The test standard for compressive strength of preheated pellets and roasted pellets refers to GB/T14201-2018, and the test standard for total iron (TFe) grade of roasted pellets refers to GB/T 6730.65-2009.

Table 1 Test results of use examples 1-3 and comparative examples 1-3

| | | | | | Preheated | | |
|---|---|---|---|---|---|---|---|
| | | Iron ore pellets | | | pellets | Roasted pellets | |
| | | Drop | Compressive | Shock | Compressive | Compressive | |
| | | Number | strength | Temperature | strength | strength | TFe |
| Groups | Binder ratio | (times/0.5 m) | (N/P) | (° C.) | (N/P) | (N/P) | grade |
| Use | 0.4% | 5.07 | 12.14 | 483 | 507 | 2149 | 61.23 |
| example 1 | Composite | | | | | | |
| | binder | | | | | | |
| Use | 0.5% | 5.32 | 12.39 | 481 | 513 | 2153 | 61.19 |
| example 2 | Composite | | | | | | |
| | binder | | | | | | |
| Use | 0.6% | 5.79 | 13.11 | 474 | 522 | 2164 | 61.17 |
| example 3 | Composite | | | | | | |
| | binder | | | | | | |
| Comparative | 3.0% | 5.88 | 12.51 | 492 | 508 | 2117 | 60.05 |
| example 1 | Calcium- | | | | | | |
| | based | | | | | | |
| | bentonite | | | | | | |
| Comparative | 2.0% | 5.63 | 13.01 | 476 | 495 | 2103 | 60.56 |
| example 2 | Sodium- | | | | | | |
| | based | | | | | | |
| | bentonite | | | | | | |
| Comparative | 1.0% | 4.31 | 11.07 | 453 | 477 | 1979 | 61.28 |
| example 3 | Peridur | | | | | | |

From the results in Table 1, it can be seen that both sodium-based bentonite and calcium-based bentonite would significantly reduce the iron grade of finished pellets. Peridur has less effect on the iron grade of finished pellets, and the strength of preheated pellets and roasted pellets prepared by using Peridur is poor. By comparison, when used for producing iron ore pellets, the composite organic binder according to the present disclosure not only has a lower dosage, but also would not reduce the strength and iron grade of pellets, and thus is conducive to increasing production, saving coking, saving energy and reducing emissions of the blast furnace.

The foregoing descriptions are merely preferred embodiments of the present disclosure. It should be noted that those of ordinary skill in the art may make several improvements or refinements without departing from the principle of the present disclosure. These improvements or refinements shall also fall within the scope of the present disclosure.

1. A composite organic binder which is made of the following components in mass percentages: 0.97-1.13% of polyethylene oxide, and 98.87-99.03% of a papermaking sludge.

2. The composite organic binder of claim 1, wherein the polyethylene oxide has a number average molecular weight of 6.5-8.5 million.

3. The composite organic binder of claim 1, wherein the polyethylene oxide has a mass fraction of polyethylene oxide with a particle size not larger than 0.074 mm of not less than 99%.

4. The composite organic binder of claim 1, wherein the papermaking sludge has a mass fraction of organic matters of 40-50%.

5. The composite organic binder of claim 1, wherein the papermaking sludge has a mass fraction of papermaking sludge with a particle size not larger than 0.074 mm of not less than 90%.

6. The composite organic binder of claim 1, wherein the papermaking sludge has a moisture content of 15-16%.

7. A method for preparing a composite organic binder, comprising mixing polyethylene oxide and a papermaking sludge according to the following composition in mass percentages: 0.97-1.13% of the polyethylene oxide, and 98.87-99.03% of the papermaking sludge, to obtain the composite organic binder.

8. A method for using a composite organic binder, comprising mixing the composite organic binder and an iron ore concentrate power, and pelletizing to obtain iron ore pellets, wherein the composite organic binder is made of the following components in mass percentages: 0.97-1.13% of polyethylene oxide, and 98.87-99.03% of a papermaking sludge.

9. The method of claim 8, wherein the iron ore concentrate powder has a mass fraction of iron ore concentrate powder with a particle size not larger than 0.074 mm of not less than 85%, and a specific surface area of not less than 1500 cm²/g.

10. The method of claim 8, wherein the composite organic binder is used in an amount of 0.4-0.6% of the dry weight of the iron ore concentrate powder.

11. The composite organic binder of claim 2, wherein the polyethylene oxide has a mass fraction of polyethylene oxide with a particle size not larger than 0.074 mm of not less than 99%.

12. The composite organic binder of claim 4, wherein the papermaking sludge has a mass fraction of papermaking sludge with a particle size not larger than 0.074 mm of not less than 90%.

13. The method of claim 7, wherein the polyethylene oxide has a number average molecular weight of 6.5-8.5 million Da.

14. The method of claim 7, wherein the polyethylene oxide has a mass fraction of polyethylene oxide with a particle size not larger than 0.074 mm of not less than 99%.

15. The method of claim 7, wherein the papermaking sludge has a mass fraction of organic matters of 40-50%.

16. The method of claim 7, wherein the papermaking sludge has a mass fraction of papermaking sludge with a particle size not larger than 0.074 mm of not less than 90%.

17. The method of claim 7, wherein the papermaking sludge has a moisture content of 15-16%.

18. The method of claim 11, wherein the polyethylene oxide has a mass fraction of polyethylene oxide with a particle size not larger than 0.074 mm of not less than 99%.

19. The method of claim 11, wherein the papermaking sludge has a mass fraction of papermaking sludge with a particle size not larger than 0.074 mm of not less than 90%.

20. The method of claim 8, wherein the polyethylene oxide has a number average molecular weight of 6.5-8.5 million.
